(19) United States
(12) Patent Application Publication
(10) Pub. No.: US 2017/0278112 A1
(43) Pub. Date: Sep. 28, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Daisuke IKEDA, Kanagawa (JP); Masatsugu TONOIKE, Kanagawa (JP); Jun SHINGU, Kanagawa (JP); Yusuke UNO, Kanagawa (JP); Yusuke YAMAURA, Kanagawa (JP)

(73) Assignee: FUJI XEROX CO., LTD., Tokyo (JP)

(21) Appl. No.: 15/217,654

(22) Filed: Jul. 22, 2016

(30) Foreign Application Priority Data
Mar. 25, 2016 (JP) 2016-061558

(51) Int. Cl. G06Q 30/02

(52) U.S. Cl. CPC G06Q 30/0201

(57) ABSTRACT

An information processing apparatus includes a detection unit that detects a motion performed by each customer at least at a location of a product display section in a store, a first acquisition unit that acquires information concerning a location of the customer whose motion has been detected, and a first time point at which the customer motion has been detected, a second acquisition unit that acquires information concerning a product that has been purchased by each customer in the store, and a second time point at which the product has been purchased, and a generation unit that generates data that associates the product display section at the location of the customer whose motion has been detected with the product that has been purchased at the second time point having a predetermined relationship with the first time point if the detected motion is a predetermined motion.

### CROSS-REFERENCE TO RELATED APPLICATIONS

This application is based on and claims priority under 35 USC 119 from Japanese Patent Application No. 2016-061558 filed Mar. 25, 2016.

### BACKGROUND

### TECHNICAL FIELD

The present invention relates to an information processing apparatus, an information processing method, and a non-transitory computer readable medium.

Corporations that run stores analyze motions of each person in a store, and determine the layout of the product display racks and products to be displayed in each shelf of the rack.

### SUMMARY

According to an aspect of the invention, there is provided an information processing apparatus. The information processing apparatus includes a detection unit that detects a motion performed by each customer at least at a location of a product display section in a store where the product display section that displays products is placed, a first acquisition unit that acquires information concerning a location of the customer whose motion has been detected, and a first time point at which the motion has been detected, a second acquisition unit that acquires information concerning a product that has been purchased by each customer in the store, and a second time point at which the product has been purchased, and a generation unit that generates data that associates the product display section at the location of the customer whose motion has been detected with the product that has been purchased at the second time point having a predetermined relationship with the first time point if the detected motion is a predetermined motion.

### BRIEF DESCRIPTION OF THE DRAWINGS

Exemplary embodiments of the present invention will be described in detail based on the following figures, wherein:

FIG. 1 generally illustrates an information processing system of a first exemplary embodiment of the present invention;

FIG. 2 is a block diagram illustrating the configuration of an information processing apparatus of the first exemplary embodiment;

FIG. 3A illustrates the configuration of data stored on a detection data memory of the first exemplary embodiment;

FIG. 3B illustrates the configuration of data stored on a motion data memory of the first exemplary embodiment;

FIG. 3C illustrates the configuration of data stored on a purchase data memory of the first exemplary embodiment;

FIG. 3D illustrates the configuration of data stored on a display section data memory of the first exemplary embodiment;

FIG. 3E illustrates the configuration of data stored on a product display data memory of the first exemplary embodiment;

FIG. 4 is a flowchart illustrating a process performed by the information processing apparatus of the first exemplary embodiment;

FIG. 5 illustrates a specific operation performed in step S9 of the flowchart FIG. 4 of the first exemplary embodiment;

FIG. 6 illustrates the configuration of product display data generated by the information processing apparatus of the first exemplary embodiment;

FIG. 7 illustrates an example of the motion of a customer in the store; and

FIG. 8 illustrates a specific operation performed in step S9 of the flowchart of FIG. 4 in accordance with a second exemplary embodiment of the present invention.

### DETAILED DESCRIPTION

### First Exemplary Embodiment

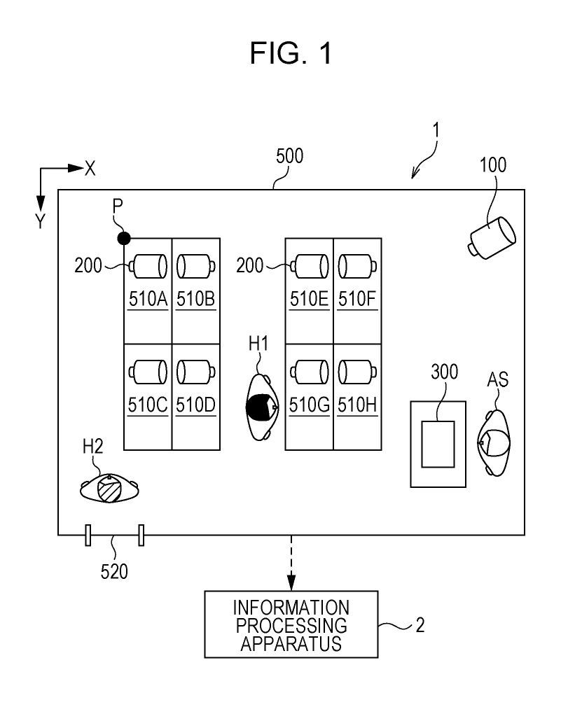

FIG. 1 generally illustrates an information processing system 1 of a first exemplary embodiment of the present invention. FIG. 1 is a plan view of a store 500, such as a convenience store, a supermarket, or a department store. The store 500 includes gondolas 510 as examples of product display section on which products are displayed. The gondola 510 is a shelf on which products are displayed. Eight condoles 510A through 510H are arranged as the gondolas 510. Each customer having entered through a doorway 520 of the store 500 (for example, customers H1 and H2) may pick up a product with his or her hand he or she wants to purchase from among the products displayed on the gondola 510.

The number of gondolas 510 may be seven or less or nine or more, and the gondolas are not limited to any particular shape, size, or installation position.

A store terminal 300 operated by a clerk AS is located at a checkout of the store 500. The store terminal 300 is a computer referred to as a point of sale (POS) register. A customer carries a product in his or her hand to the checkout and makes payment in the store 500. When a product being sold in the store 500 is purchased by a customer, the store terminal 300 performs an operation for payment, issues a receipt describing purchase results of the product, and generates data including information concerning the purchase results (“purchase data”).

An imaging device 100 that images the inside of the store 500 from above is installed at a location. The imaging device 100 generally images the inside of the store 500. Plural imaging devices 100 may be installed as appropriate. An imaging device 200 configured to image the inside of the store 500 with respect to the flow line of a customer is installed in each of the gondolas 510A through 510H. The imaging devices 100 and 200 are cameras that take a moving image.

Without human intervention, an information processing system 1 generates product display data that associates each of multiple gondolas 510 (510A through 510H) with products displayed on thereon. An information processing apparatus 2 in the information processing system 1 generates the product display data in accordance with pickup images from the imaging devices 100 and 200.

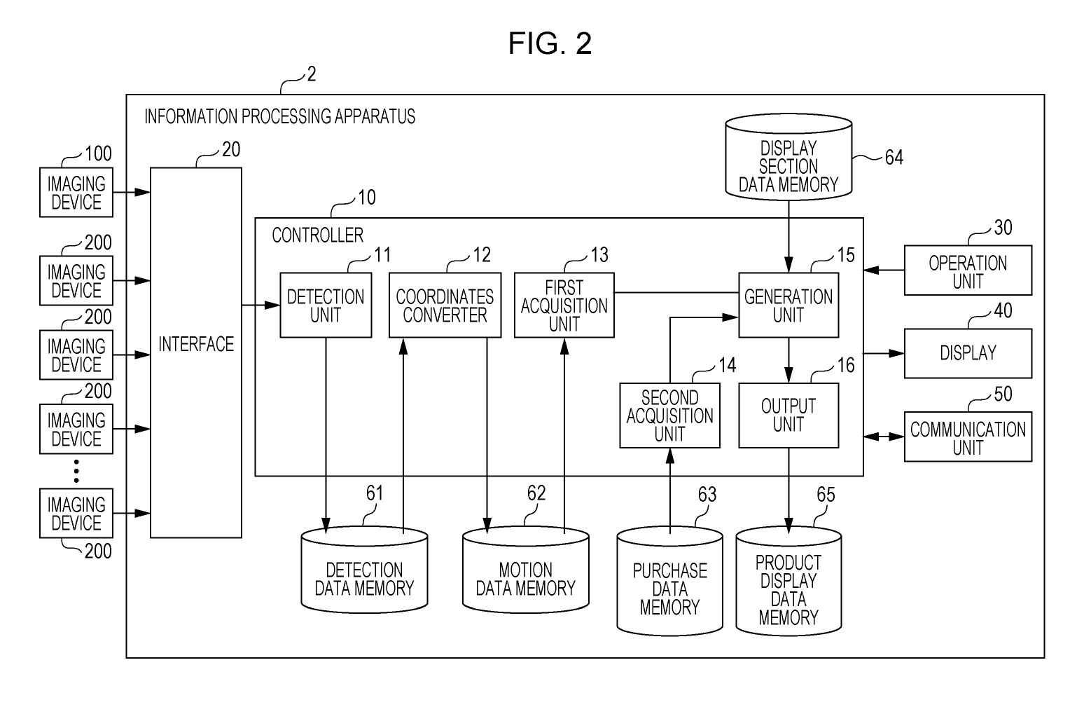

FIG. 2 is a block diagram illustrating the configuration of the information processing apparatus 2 of the first exemplary embodiment. The information processing apparatus 2 includes a controller 10, interface 20, operation unit 30, display 40, communication unit 50, detection data memory 61, motion data memory 62, purchase data memory 63, display section data memory 64, and product display data memory 65.

The controller 10 includes a processor including a central processing unit (CPU), a read-only memory (ROM), and a random-access memory (RAM), and an image processing circuit, such as an application specific integrated circuit (ASIC). The CPU controls each unit of the information processing apparatus 2 by reading a program from the ROM onto the RAM and then executing the program. The image processing circuit is controlled by the CPU, and is used in a variety image processing operations that is executed by the controller 10.

The interface 20 interconnects the information processing apparatus 2 to each of the imaging devices 100 and 200. The imaging devices 100 and 200 take images and outputs pickup images acquired through the imaging to the interface 20. The operation unit 30 includes a touch sensor or a physical key, and receives an operation performed by a user on the touch sensor or the physical key. The display 40 includes a liquid-crystal display, and displays an image on the display screen thereof. The communication unit 50 includes a modem, and is connected to a communication network, such as the Internet, for communication.

The detection data memory 61, the motion data memory 62, the purchase data memory 63, the display section data memory 64, and the product display data memory 65 are constructed of one or more memory devices (such as hard disks).

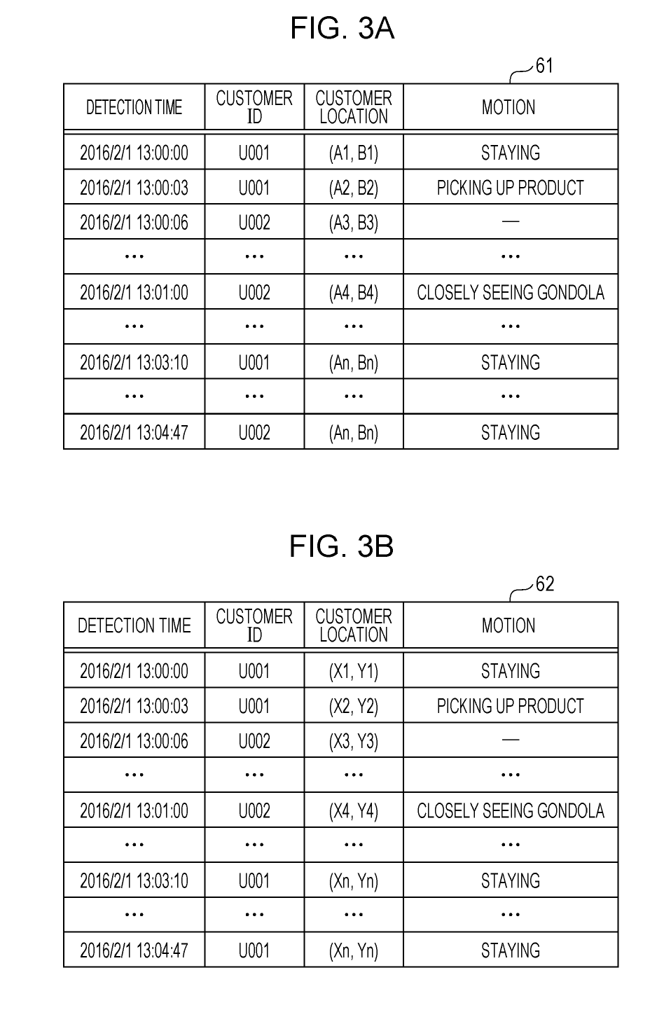

FIG. 3A illustrates the configuration of data stored on the detection data memory 61. Referring to FIG. 3A, the detection data memory 61 stores detection data that associates detection time, a customer identity (ID), a customer location, and a motion of the customer on each record. The detection time is includes information concerning the day, the month, and the year in addition to information about the hours, the minutes, and the seconds. The customer ID is identity information uniquely identifying each customer of the store 500. A customer ID “U001” may now be assigned to a customer H1 and a customer ID “U002” may now be assigned to a customer H2 as illustrated in FIG. 1. The customer location is data indicating the location of the customer identified by the customer ID. The customer location is represented by a format (Ai, Bi) (i represents a natural number). The customer location is represented in a coordinate system of the pickup image. The motion is data indicating the motion performed by the customer identified by the customer ID. Referring to FIG. 3A, a motion “staying” means that the customer is standing still, a motion “picking up a product in hand” means that the customer picks up a product in his or her hand from the gondola 510, and a motion “closely seeing gondola” means that the customer closely sees the gondola 510 but does not yet pick up any product from the gondola 510. The detection time is examples of a first time point or a third time point of the exemplary embodiments, at which the motion of the customer has been detected.

FIG. 3B illustrates the configuration of data stored on the motion data memory 62. Referring to FIG. 3B, the motion data memory 62 stores motion data that associates the detection time, the customer ID, the customer location, and the motion on each record. The detection time, the customer ID, and the motion are identical to those stored on the detection data memory 61. The customer location is a value into which the customer location stored on the detection data memory 61 is converted in terms of coordinate system. The customer location on the motion data memory 62 has a format (Xi, Yi) (i is a natural number). The customer location is represented in an XY coordinate system of FIG. 1. The XY coordinate system is the rectangular coordinate system representing a position on a horizontal plane of the store 500. In this way, the motion data memory 62 stores the location of each customer at each detection time, and information of the motion performed by the customer.

FIG. 3C illustrates the configuration of data stored on the purchase data memory 63. Referring to FIG. 3C, the purchase data memory 63 stores purchase data that associates purchase time, a receipt ID, a product, and a category. In the first exemplary embodiment, the purchase time includes information of the day, the month, and the year in addition to the information of the hours, the minutes, and the seconds. The receipt ID is identification information that uniquely identifies a receipt issued by the store terminal 300. The product is the one that has been purchased. The category indicates the category to which the product belongs. Referring to FIG. 3C, products “cream bun” and “melon bread” belong to the category of “bread and bun”, and product “sports drink” belongs to the category of “drinks”. One or more pieces of purchase data having a common receipt ID indicate purchase results by one customer. The purchase data memory 63 stores information related to the purchase results of products of each customer. The purchase time is an example of a first time point of the exemplary embodiments, and indicates time at which the product has been purchased by the customer.

FIG. 3D illustrates the configuration of data stored on the display section data memory 64. Referring to FIG. 3D, the display section data memory 64 stores display section data that associates a gondola ID, a gondola location, a width, and a length of the gondola on each record.

The gondola ID is identification information uniquely identifying the gondola 510. The IDs of the gondolas 510A through 510H are respectively “G001” through “G008”. The gondola location represents the top left corner of the gondola 510 in a plan view of the store 500 using the XY coordinate system. For example, the location (XA, YA) of the gondola 510A indicates point P of FIG. 1. The width and the length are the width and the length of the gondola 510. The length of the gondola 510 along the Y axis is the width, and the length of the gondola 510 along the Y axis is the length. Each of the gondolas 510A through 510H has a width “L1” and a length “L2”. The display section data memory 64 stores information identifying the location and the size of each gondola 510.

The display section data on the display section data memory 64 is input to the information processing apparatus 2 in advance by operating the operation unit 30.

FIG. 3E illustrates the configuration of data stored on the product display data memory 65. As illustrated in FIG. 3E, the product display data memory 65 stores product display data that associates a gondola ID, a category, a width, and a length of the gondola on each record. The gondola ID, the width, and the length are identical to those stored on the display section data memory 64. The category indicates a category to which a product displayed on the gondola 510 identified by the gondola ID belongs to. As illustrated in FIG. 3E, each cell is blank on the product display data memory 65. The product display data, when generated, is recorded on the product display data memory 65.

Turning to FIG. 2, the controller 10 implements functions of a detection unit 11, a coordinates converter 12, a first acquisition unit 13, a second acquisition unit 14, a generation unit 15, and an output unit 16.

The detection unit 11 detects the motion performed by each customer in the store 500. The detection unit 11 analyzes pickup images acquired from the imaging devices 100 and 200 via the interface 20, and detects the motion performed by each customer. Based on the detected motion, the detection unit 11 records detection data on the detection data memory 61. For example, the detection unit 11 may detect the motion “staying” if a customer stands still at the same location for a predetermined period of time.

The detection unit 11 further detects, as a customer's motion to purchase a product (hereinafter referred to as a “purchase time operation”), a customer's motion to pick up the product in his or her hand from the gondola 510, a customer's motion to move with the product in his or her hand, and a customer's motion to closely see the product on the gondola 510. The customer's motion to closely see the product on the gondola 510 may be detected in accordance with the direction of the face of the customer, the time duration throughout which the customer has stayed at the gondola 510, an accumulated time duration while the customer has closely seen the same gondola 510. If the customer has stayed for a predetermined time duration while facing the gondola 510, the customer is determined to be closing seeing the product on the gondola 510. The customer's motion to pick up the product in his or her hand from the gondola 510, the customer's motion to move with the product in his or her hand, and the customer's motion to closely see the product on the gondola 510 may be determined on condition that the distance between the customer and the gondola 510 is equal to or below a predetermined distance. In this way, the accuracy of detecting the purchase time operation is increased.

In accordance with the first exemplary embodiment, the detection unit 11 detects as the purchase time operation related to payment the customer's motion to move to the checkout and to stay there.

The coordinates converter 12 acquires the detection data from the detection data memory 61, converts coordinates of the location of the customer, and stores the converted data as the motion data onto the motion data memory 62. The time of the customer's motion to pick up the product in his or her hand from the gondola 510, the customer's motion to move with the product in his or her hand, or the customer's motion to closely see the product on the gondola 510 is an example of the first time point of the exemplary embodiments. The time of the purchase time operation related to payment is an example of the third time point of the exemplary embodiments.

The first acquisition unit 13 acquires the motion data from the motion data memory 62. The second acquisition unit 14 acquires the purchase data from the purchase data memory 63.

Based on the motion data acquired by the first acquisition unit 13 and the purchase data acquired by the second acquisition unit 14, the generation unit 15 generates the product display data that associates the gondola 510 with products displayed on the gondola 510. The generation unit 15 associates the gondola 510 at the customer location at the detection of the purchase time operation with the product purchased at the purchase time having a predetermined relationship with the detection time of the purchase time operation. The predetermined relationship is that the detection time is prior to the purchase time, and that the detection time and the purchase time fall within a predetermined time range. The predetermined relationship may also be that the detection time of the purchase time operation related to payment and the purchase time fall within a predetermined time range.

The generation unit 15 identifies the gondola 510 at the location of the customer in accordance with the location of the customer recognized from the pickup image, and the display section data recorded on the display section data memory 64. For example, the generation unit 15 identifies as the gondola at the location of the customer the gondola 510 closest to the location of the customer or the gondola 510 the customer faces or sees.

The product display data that associates the gondola 510 with the category of the products is described below. This means that the gondola 510 is associated with the products belonging to the category.

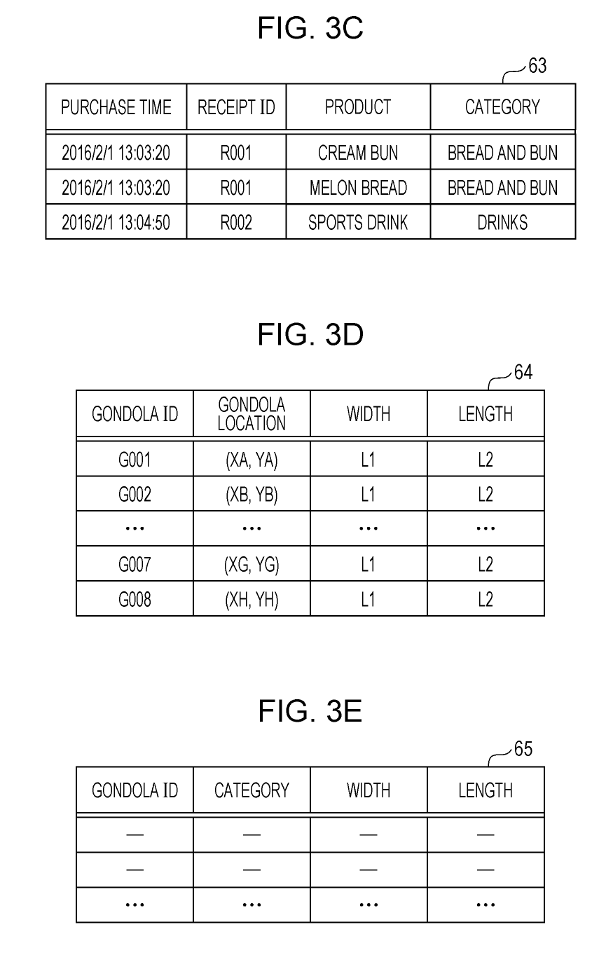

FIG. 4 is a flowchart illustrating a process performed by the information processing apparatus 2.

The controller 10 acquires the pickup image from the imaging devices 100 and 200 via the interface 20 (step S1). The controller 10 detects the motion of a customer from the pickup image acquired in step S1 (step S2), and records the detection data onto the detection data memory 61 (step S3). The controller 10 records the detection data of each customer by attaching a customer ID to the customer recognized from the pickup image and keeping track of the customer.

The controller 10 acquires the detection data from the detection data memory 61, coordinates-converts the location of the customer (step S4), and records the motion data on the motion data memory 62 (step S5). The controller 10 then determines whether to generate the product display data (step S6). If the determination result in step 56 is “no”, the controller 10 returns to step S1. For example, the controller 10 returns to step S1 if the product display data is generated after further motion data is accumulated on the motion data memory 62. The controller 10 repeats operations in steps S1 through S6 (no branch from step S6).

If the determination result in step 56 is “yes”, the controller 10 acquires the motion data from the motion data memory 62 (step S7). The motion data of FIG. 3B may now be acquired, for example. The controller 10 acquires the purchase data from the purchase data memory 63 (step S8). The purchase data of FIG. 3C may now be acquired.

The controller 10 generates the product display data (step S9).

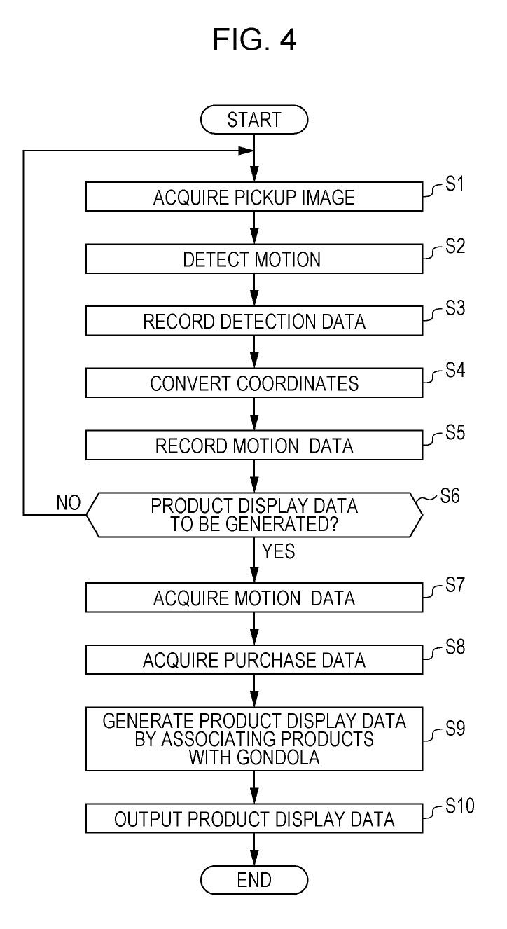

FIG. 5 illustrates a specific operation performed in step 59. Firstly, the controller 10 associates the receipt ID of the purchase data with the customer ID of the motion data. In the store 500, payment is performed at the checkout where the store terminal 300 is installed. A customer who wants to purchase a product goes to the checkout. The location of the checkout is (Xn, Yn) in the XY coordinate system. The detection time at which the customer has stayed and the time at which the receipt has been issued, namely, the purchase time of the product falls within a predetermined time range. Furthermore, the detection time and the purchase time may be the same time or may be very close to each other. The purchase data including a receipt ID “R001” indicates that purchase data is “2016/2/1 13:03:20”. The controller 10 thus associates the receipt ID “R001” of the purchase data having the purchase data “2016/2/1 13:03:20” with a customer ID “U001” included in motion data having detection time “2016/2/1 13:03:10”. The controller 10 also associates a receipt ID “R002” of purchase data having purchase time “2016/2/1 13:04:50” with a customer ID “U002” included in motion data having detection time “2016/2/1 13:04:47”.

If there are plural detection times falling within a predetermined time range with respect to the purchase time, the controller 10 may simply associate the receipt ID with the customer ID in accordance with the detection time closest to the purchase time.

Secondly, the controller 10 associates a customer ID with a product purchased by the customer identified by the customer ID. As illustrated in FIG. 5, the motion of picking the product by the customer H1 having the customer ID “U001” is detected at location data (X2, Y2) within a predetermined time range before the detection time at which the customer H1 is detected at the checkout. In this case, the customer may possibly have picked up the product in his or her hand at the gondola 510 at the customer location (X2, Y2) (namely, the gondola 510G). If the customer H1 does not perform a purchase time operation at the location of another gondola 510, the customer H1 may have picked up, from the gondola 510G, products “cream bun”, and “melon bread” included in the purchase data having a receipt ID “R001”. The controller 10 thus associates a gondola ID “G007” with the category “bread and bun” to which the “cream bun” and the “melon bread” belong.

The motion of closely seeing the product by a customer H2 having a customer ID “U002” is detected at location data (X4, Y4) within a predetermined time range before the detection time at which the customer H2 is detected at the checkout. The customer H2 may possibly have picked up a product from the gondola 510 at the customer location (X4, Y4) (the gondola 510A in this case). If the customer H2 does not perform a purchase time operation at the location of another gondola 510, the customer H2 may have picked up, from the gondola 510A, product “sports drinks” included in the purchase data having a receipt ID “R002”. The controller 10 thus associates a gondola ID “G001” with the category “drinks” to which “sports drinks” belong.

The method of associating the gondola 510 with the product has been described with reference to FIG. 5 for exemplary purposes. The controller 10 may associate the gondola 510 with the product without depending on the purchase time operation related to payment. In such a case, the controller 10 identifies the purchase data including a receipt ID, and associates the receipt ID with a customer ID, based on the receipt ID and the detection time falling within a predetermined time range before the purchase time in the purchase data. For example, the controller 10 associates the receipt ID with the customer ID, based on the detection time closest to the purchase time. The controller 10 associates the gondola 510 at the location where the customer having the customer ID has performed the purchase time operation with the category of the product included in the purchase data having the receipt ID.

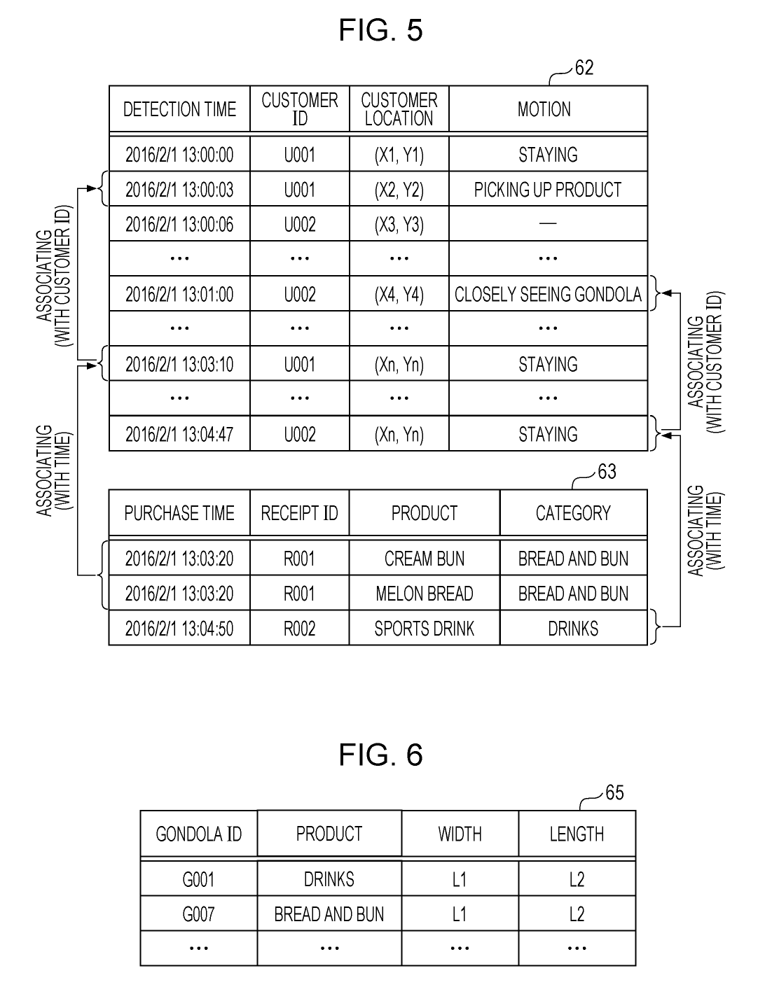

If the product display data is generated as described above, the controller 10 outputs the generated product display data (step S10). The controller 10 herein outputs the product display data to the product display data memory 65 for storage. Through the operation in step S10, the product display data memory 65 stores data as illustrated in FIG. 6. The product display data may be output by transmitting the product display data via the communication unit 50, displaying the product display data on the display 40, or printing the product display data.

The categories of products on the gondolas 510A and 510G are associated herein. By repeating the process described above, each of the gondolas 510A through 510G is associated with categories of products.

Without human intervention, the information processing apparatus 2 of the first exemplary embodiment generates the product display data that associates the gondola 510 in the store 500 with products placed on the gondola 510.

### Second Exemplary Embodiment

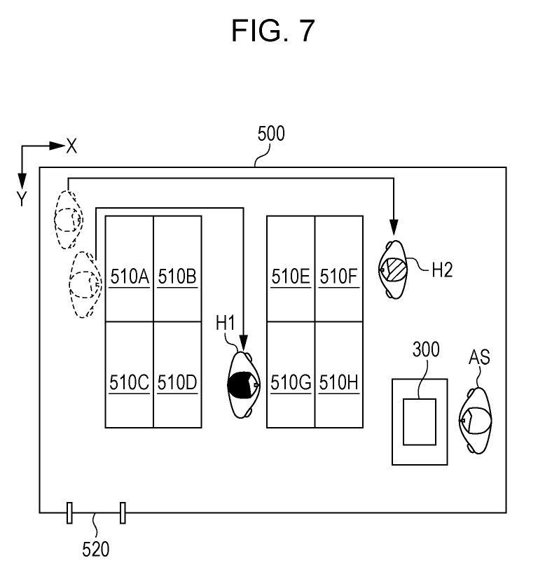

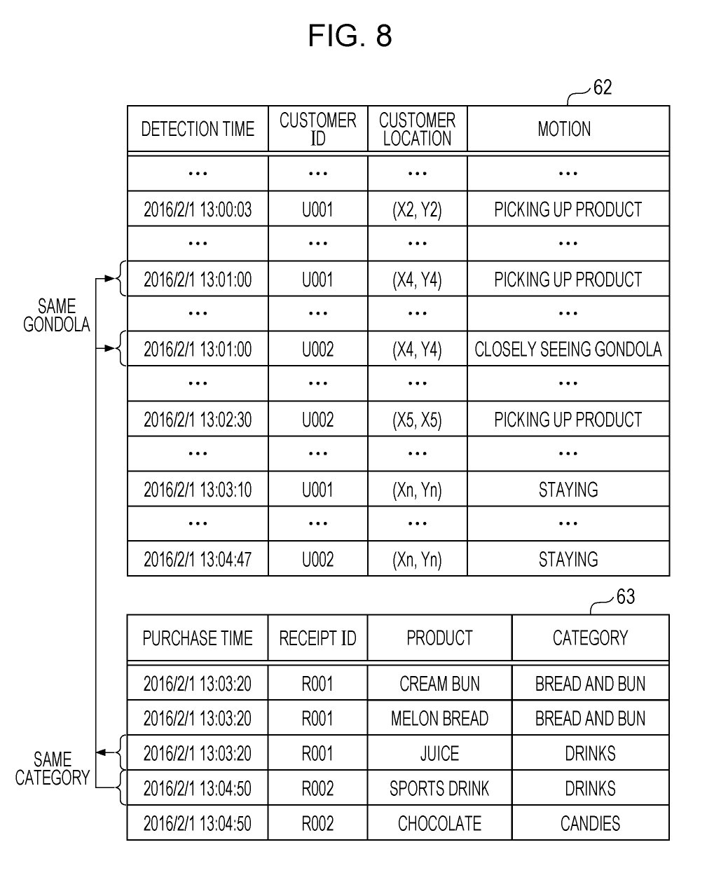

As illustrated in FIG. 7, the customer H1 may perform the purchase time operation at two locations, one location at the gondola 510A, and the other location at the gondola 510G, and the customer H2 may perform the purchase time operation at two locations, one location at the gondola 510A, and the other location at the gondola 510F. In such a case, the purchase data acquired by the controller 10 is stored on the purchase data memory 63 as illustrated in FIG. 8. Even if the purchase data of one customer (one receipt ID) is checked against the motion data of one customer, it is difficult to uniquely identify the relationship between the gondola 510 and the product displayed on the gondola 510. If a receipt ID “R001” is associated with a customer ID “U001”, this reveals that the “bread and bun” is displayed on one of the gondolas 510A and 510G and that the “drinks” are displayed on the other of the gondolas 510A and 510G but does not reveal which gondola one of the categories of the “bread and bun” and the “drinks” is displayed on. Similarly, if a receipt ID “R002” is associated with a customer ID “U002”, this reveals that the “drinks” is displayed on one of the gondolas 510A and 510F and that the “candies” are displayed on the other of the gondolas 510A and 510F but does not reveal which gondola each of the categories of the “drinks” and the “candies” is displayed on.

The controller 10 (the generation unit 15) then associates the gondola 510 at the location of two or more customers from whom the purchase time operation has been detected with products that have been purchased by the two or more customers. If the purchase data memory 63 stores data as illustrated in FIG. 8, the number of receipt IDs “R001” and “R002” associated with the category “drinks” are two. In the motion data memory 62, the number of customer IDs of customers who have performed the purchase time operation at the location (X4, Y4) of the gondola 510A is two, namely, “U001”, and “U002”. The number of customer IDs of customers who have performed the purchase time operation at the location (X2, Y2) of the gondola 510G and the number of customer IDs of customers who have performed the purchase time operation at the location (X5, Y5) of the gondola 510F are respectively one. This indicates that the two customers having purchased products belonging to the category “drinks” have performed the purchase time operation at the location of the gondola 510A. This confirms that the products belonging to the category “drinks” are displayed on the gondola 510A. The controller 10 thus associates the gondola ID “G001” with the category “drinks” to which the sports drink belong. This association confirms that the products belongings to the category “bread and bun” are displayed on the gondola 510G. The controller 10 thus associates the gondola ID “G007” with the category “bread and bun”. Also, this confirms that the products belonging to the category “candies” are displayed on the gondola 510F. The controller 10 thus associates the gondola ID “G006” with the category “candies”.

If three or more customers perform the purchase time operation at the gondola 510, the controller 10 (the generation unit 15) may simply associate the gondola 510 at the location of the three or more customers from which the purchase time operation is detected with products that have been purchased by the three or more customers. The process in such a case is easily figured out by analogy with the process discussed with reference to FIG. 8.

The information processing apparatus 2 of the second exemplary embodiment associates the gondola 510 installed in the store 500 with the products placed on the gondola 510 even if a product placed on the product display section is not identified in accordance with a motion of a customer in the store 500.

### Modifications

The present invention may be implemented in a form different from the exemplary embodiments. Modifications of the exemplary embodiments described below may be used in combination.

The controller 10 may record the detection data and motion data in response to the detection of a purchase time operation rather than successively detecting motions performed by each customer and recording the detection data and motion data.

The controller 10 may associate the gondola 510 with a product (product model) instead of or in addition to associating the gondola 510 with the category of each product. In such a case, as well, the product display data identifying each product displayed on each gondola 510 is generated.

The method of detecting the motion of a person is not limited to the detection that involves in recognizing a pickup image. For example, a device that recognizes a gesture taken by a customer (such as a three-dimensional sensor) may be used instead of or in combination with the imaging device.

The hardware configuration and the functional configuration of the information processing apparatus 2 are not limited to those described above.

The configuration and operation of the information processing system described in the exemplary embodiments may be partially omitted. For example, the configuration and operation related to coordinates conversion may be omitted.

The functions of the controller 10 in the information processing apparatus 2 may be implemented using one or more hardware circuits, or may be implemented by a processing device that executes one or more programs, or may be implemented using a combination thereof. If the functions of the controller 10 are implemented using a program, the program may be supplied in a recorded state on a non-transitory computer readable recording medium or via a network. The non-transitory computer readable recording media include a magnetic recording medium (such as a magnetic tape, a magnetic disk, a hard disk drive (HDD), a flexible disk (FD)), an optical recording medium (such as an optical disk), a magneto-optical recording medium, and a semiconductor memory. The present invention may also include an information processing method that is performed by a computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
a detection unit that detects a motion performed by each customer at least at a location of a product display section in a store where the product display section that displays products is placed;
a first acquisition unit that acquires information concerning a location of the customer whose motion has been detected, and a first time point at which the customer motion has been detected;
a second acquisition unit that acquires information concerning a product that has been purchased by each customer in the store, and a second time point at which the product has been purchased; and
a generation unit that generates data that associates the product display section at the location of the customer whose motion has been detected with the product that has been purchased at the second time point having a predetermined relationship with the first time point if the detected motion is a predetermined motion.

2. The information processing apparatus according to claim 1, wherein the detection unit further detects a motion performed by the customer at a checkout in the store,
wherein the first acquisition unit further acquires information concerning a third time point at which the customer motion has been detected at the checkout, and
wherein the generation unit associates the product display section at the location where the customer has performed the predetermined motion with the product that has been purchased by the customer, in accordance with a relationship between the second time point and the third time point.

3. The information processing apparatus according to claim 1, wherein the generation unit associates the product display section at the location where the predetermined motion has been detected from two or more customers with the products of same model that have been purchased by the two or more customers.

4. The information processing apparatus according to claim 2, wherein the generation unit associates the product display section at the location where the predetermined motion has been detected from two or more customers with the products of same model that have been purchased by the two or more customers.

5. The information processing apparatus according to claim 1, wherein the predetermined motion comprises a customer's motion to pick up a product displayed in the product display section with a customer's hand, or a customer's motion to carry the picked up product with the customer's hand.

6. The information processing apparatus according to claim 2, wherein the predetermined motion comprises a customer's motion to pick up a product displayed in the product display section with a customer's hand, or a customer's motion to carry the picked up product with the customer's hand.

7. The information processing apparatus according to claim 3, wherein the predetermined motion comprises a customer's motion to pick up a product displayed in the product display section with a customer's hand, or a customer's motion to carry the picked up product with the customer's hand.

8. The information processing apparatus according to claim 4, wherein the predetermined motion comprises a customer's motion to pick up a product displayed in the product display section with a customer's hand, or a customer's motion to carry the picked up product with the customer's hand.

9. The information processing apparatus according to claim 1, wherein the predetermined motion comprises a motion that is identified by a direction of the face of the customer, and a time duration throughout which the customer has stayed at the location of the product display section.

10. The information processing apparatus according to claim 2, wherein the predetermined motion comprises a motion that is identified by a direction of the face of the customer, and a time duration throughout which the customer has stayed at the location of the product display section.

11. The information processing apparatus according to claim 3, wherein the predetermined motion comprises a motion that is identified by a direction of the face of the customer, and a time duration throughout which the customer has stayed at the location of the product display section.

12. The information processing apparatus according to claim 4, wherein the predetermined motion comprises a motion that is identified by a direction of the face of the customer, and a time duration throughout which the customer has stayed at the location of the product display section.

13. The information processing apparatus according to claim 5, wherein the predetermined motion comprises a motion that is identified by a direction of the face of the customer, and a time duration throughout which the customer has stayed at the location of the product display section.

14. The information processing apparatus according to claim 6, wherein the predetermined motion comprises a motion that is identified by a direction of the face of the customer, and a time duration throughout which the customer has stayed at the location of the product display section.

15. The information processing apparatus according to claim 7, wherein the predetermined motion comprises a motion that is identified by a direction of the face of the customer, and a time duration throughout which the customer has stayed at the location of the product display section.

16. The information processing apparatus according to claim 8, wherein the predetermined motion comprises a motion that is identified by a direction of the face of the customer, and a time duration throughout which the customer has stayed at the location of the product display section.

17. The information processing apparatus according to claim 1, wherein the predetermined motion comprises a motion that is identified by a time duration throughout which the customer has seen the product display section.

18. The information processing apparatus according to claim 1, wherein the predetermined motion comprises a motion identified by a distance between the customer and the product display section.

19. An information processing method, comprising:
detecting a motion performed by each customer at least at a location of a product display section in a store where the product display section that displays products is placed;
acquiring information concerning a location of the customer whose motion has been detected, and a first time point at which the customer motion has been detected;
acquiring information concerning a product that has been purchased by each customer in the store, and a second time point at which the product has been purchased; and
generating data that associates the product display section at the location of the customer whose motion has been detected with the product that has been purchased at the second time point having a predetermined relationship with the first time point if the detected motion is a predetermined motion.

20. A non-transitory computer readable medium storing a program causing a computer to execute a process for processing information, the process comprising:
detecting a motion performed by each customer at least at a location of a product display section in a store where the product display section that displays products is placed;
acquiring information concerning a location of the customer whose motion has been detected, and a first time point at which the customer motion has been detected;
acquiring information concerning a product that has been purchased by each customer in the store, and a second time point at which the product has been purchased; and
generating data that associates the product display section at the location of the customer whose motion has been detected with the product that has been purchased at the second time point having a predetermined relationship with the first time point if the detected motion is a predetermined motion.
